(19) United States
(12) Patent Application Publication
(10) Pub. No.: US 2026/0302858 A1
(43) Pub. Date: Oct. 1, 2026

(54) ROTOR, ACTUATOR, AND METHOD FOR MANUFACTURING ROTOR

(71) Applicant: AISIN CORPORATION, Kariya (JP)

(72) Inventors: Keita NAKASHIMA, Kariya-shi (JP); Takemitsu Sumiya, Kariya-shi (JP)

(73) Assignee: AISIN CORPORATION, Kariya (JP)

(21) Appl. No.: 19/567,499

(22) Filed: Mar. 16, 2026

(30) Foreign Application Priority Data
Mar. 27, 2025 (JP) 2025-053098
Dec. 24, 2025 (JP) 2025-280545

(51) Int. Cl. H02K 1/30; H02K 5/173; H02K 5/22; H02K 7/116; H02K 11/215; H02K 15/028; H02K 21/14

(52) U.S. Cl. CPC H02K 1/30; H02K 5/1735; H02K 5/225; H02K 7/116; H02K 11/215; H02K 15/028; H02K 21/14; H02K 2211/03

(57) ABSTRACT

A rotor of the present disclosure is a rotor of a motor, and the rotor includes: a magnet body having a cylindrical shape; a rotor shaft provided on a radially inner side of the magnet body to be separated from the magnet body; and a coupling member that couples the magnet body and the rotor shaft, wherein the coupling member is a disk-shaped member including: an outer peripheral portion located in the magnet body; and an intermediate portion provided on a radially inner side from the outer peripheral portion.

### CROSS REFERENCE TO RELATED APPLICATIONS

This application is based on and claims priority under 35 U.S.C. § 119 to Japanese Patent Application No. 2025-280545, filed on Dec. 24, 2025, and No. 2025-053098, filed on Mar. 27, 2025, the entire content of which are incorporated herein by reference.

### TECHNICAL FIELD

The present disclosure relates to a rotor of a motor, an actuator including the motor having the rotor, and a method for manufacturing the rotor.

### BACKGROUND DISCUSSION

JP 2016-109295 A discloses an actuator including: a motor having a rotating shaft; an output shaft disposed coaxially with the rotating shaft; a rotating shaft side gear provided to be rotatable integrally with the rotating shaft; an output shaft side gear provided to be rotatable integrally with the output shaft; an intermediate gear constituting body that has a first intermediate gear meshing with the rotating shaft side gear and the output shaft side gear and being provided between the rotating shaft side gear and the output shaft side gear and that has a second intermediate gear being provided to be rotatable integrally with the first intermediate gear and being disposed further on a radially outer side of the rotating shaft than the first intermediate gear is; and a first bearing that supports an end of the intermediate gear constituting body on the first intermediate gear side and a second bearing that supports an end of the intermediate gear constituting body on the second intermediate gear side.

In JP 2016-109295 A, a rotor includes: a rotating shaft (also referred to as a rotor shaft); a magnet; and a coupling member that couples the rotating shaft.

Specifically, the coupling member integrally includes: a cylindrical portion that fixes the magnet; and a coupling portion that couples the cylindrical portion and the rotating shaft, the coupling portion is thick, and the coupling member has a large weight.

Therefore, it is assumed that an impact load of an inertia of the rotor is large when the actuator suddenly stops.

Therefore, there is a concern that the weight increases when, in order to increase the strength of the portion receiving the impact load, the thickness of the portion receiving the impact load is increased or a component for reinforcement is used.

A need thus exists for a rotor, an actuator and a method for manufacturing the rotor which are not susceptible to the drawback mentioned above.

### SUMMARY

(1) A rotor of the present disclosure is a rotor of a motor, and the rotor includes:
a magnet body having a cylindrical shape;
a rotor shaft provided on a radially inner side of the magnet body to be separated from the magnet body; and
a coupling member that couples the magnet body and the rotor shaft,
wherein the coupling member is a disk-shaped member including:
an outer peripheral portion located in the magnet body; and
an intermediate portion provided on a radially inner side from the outer peripheral portion.

(2) An actuator according to the present disclosure includes:
a motor including the rotor according to the above (1); and
an output shaft that rotates by rotation of the motor; and
a reduction mechanism provided between the motor and the output shaft, the reduction mechanism including a plurality of gears that transmit the rotation of the motor to the output shaft.

(3) A manufacturing method of the present disclosure is a method for manufacturing a rotor of a motor, and the method includes:
a first step of manufacturing a coupling member that couples a magnet body having a cylindrical shape and a rotor shaft;
a second step of integrally providing the magnet body on the coupling member; wherein the first step includes:
a pressing step of forming a disk-shaped member having an opening portion in a central portion of the disk-shaped member by press working; and
a burring step of performing burring processing on the opening portion to form a cylindrical wall portion that rises on one side and in which the rotor shaft is inserted.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of an actuator of an embodiment according to the present disclosure;

FIG. 2 is a perspective view illustrating a coupling member of the embodiment according to the present disclosure;

FIG. 3 is a perspective view illustrating a state in which a magnet body is provided on the coupling member of the embodiment according to the present disclosure; and

FIG. 4 is a perspective view illustrating a disk-shaped plate member formed in a pressing step of the embodiment according to the present disclosure.

### DETAILED DESCRIPTION

Hereinafter, with reference to the accompanying drawings, a mode for carrying out the present disclosure (hereinafter, referred to as an “embodiment”) will be described in detail.

Note that the same elements are denoted by the same numbers or reference signs throughout the description of the embodiment.

In addition, the dimensional ratios in the drawings are different from actual dimensional ratios, and are merely drawn for easy understanding of the description, and it is not guaranteed that the same portions are drawn with the same dimensions between the drawings.

Furthermore, in the drawings, only a part of a plurality of parts having the same attribute is sometimes denoted by reference signs for ease of viewing.

### Embodiment

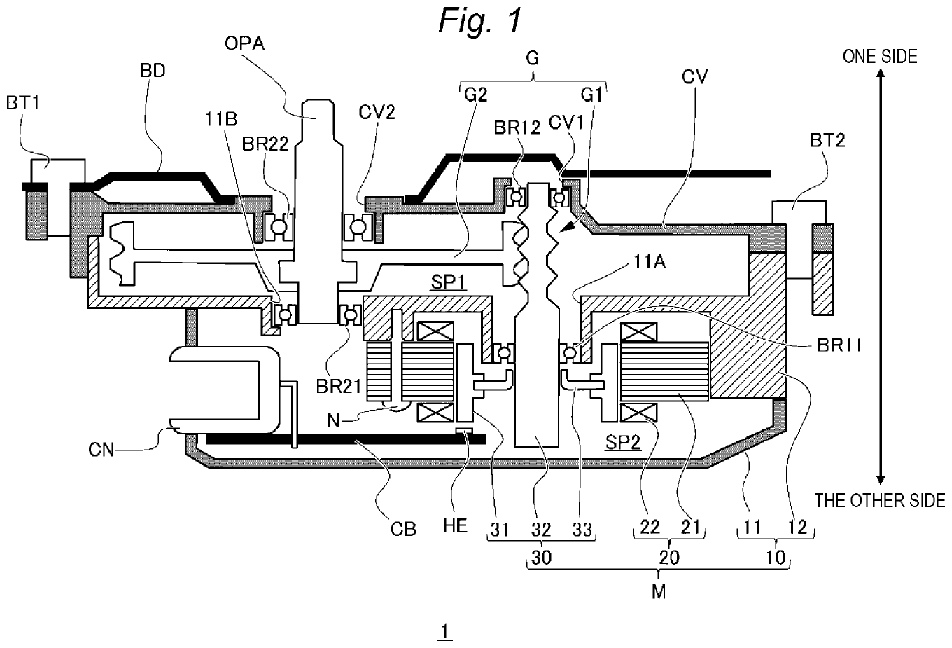

With reference to FIGS. 1 to 4, an actuator 1 of the embodiment according to the present disclosure will be described.

While the actuator 1 is being described, a rotor 30 and the like of a motor M of the embodiment according to the present disclosure will also be described.

Furthermore, a method for manufacturing the rotor 30 of the motor M will also be described after the actuator 1 and the like are described.

FIG. 1 is a cross-sectional view of the actuator 1 of the embodiment according to the present disclosure.

For example, the actuator 1 of the embodiment according to the present disclosure can be suitably used as a power source of a drive unit for moving a sliding door of a vehicle such as an automobile, but may be used in a place other than the sliding door.

In the description of the motor M, a direction in which a rotor shaft 32 serving as a rotating shaft of the motor M extends is defined as an axial direction, and a direction that is around the rotor shaft 32 and centers the rotor shaft 32 is defined as a circumferential direction.

When it is necessary to indicate a direction in the axial direction, one side in the axial direction is defined as one side in the axial direction (one axial side), and the other in the axial direction is defined as the other side in the axial direction (the other axial side).

Further, when viewed in a plane orthogonal to the axial direction, a side farther from the rotor shaft 32 is defined as a radially outer side, a side closer to the rotor shaft 32 is defined as a radially inner side, and a center when viewed in the radial direction is defined as a radial center (radially central portion).

### Actuator 1

As illustrated in FIG. 1, the actuator 1 includes: the motor M; an output shaft OPA that rotates by rotation of the motor M; and a reduction mechanism G that is interposed between the motor M and the output shaft OPA and transmits the rotation of the motor M to the output shaft OPA.

In addition, the actuator 1 includes: a circuit board CB that is provided with a rotation angle sensor (for example, a hall element HE) to detect a rotation angle of the rotor 30 and controls the rotation of the motor M; a connector CN electrically connected to the circuit board CB; and a cover CV that is provided on one side of a motor housing part 10 to be described later and forms an accommodation space SP1 accommodating the reduction mechanism G between the cover CV and the motor housing part 10.

The cover CV is attached to an attachment portion of a vehicle body BD of an automobile or the like with a bolt BT1, and the actuator 1 is thereby fixed to the vehicle body BD.

The cover CV is fixed to a second member 12 of the motor housing part 10 to be described later with a bolt BT2.

### Motor M

The motor M includes: the motor housing part 10; a stator 20 provided in the motor housing part 10; and the rotor 30 rotatably provided on a radially inner side of the stator 20.

### Motor Housing Part 10

The motor housing part 10 includes: a first member 11 provided on the other side; and the second member 12 provided on one side of the first member 11, and the first member 11 and the second member 12 form an accommodation space SP2 that accommodates the stator 20 and the rotor 30.

Note that the first member 11 and the second member 12 are integrated by using bolts or the like at portions not illustrated in the drawing.

The circuit board CB is also accommodated in the accommodation space SP2, and the connector CN is fixed to the first member 11 so as to be accessible from the outside to the connector CN electrically connected to the circuit board CB.

On the other hand, the second member 12 includes: a first opening 11A that is provided at a position corresponding to the rotor shaft 32 and that leads a screw-shaped gear G1 (also referred to as a worm) formed on one side of the rotor shaft 32 of the rotor 30, toward the accommodation space SP1 side; and a second opening 11B that is provided at a position corresponding to the output shaft OPA and in which an end on the other side of the output shaft OPA is disposed.

Note that, in the present embodiment, the screw-shaped gear G1 is formed on the one side of the rotor shaft 32; however, the screw-shaped gear G1 separate from the rotor shaft 32 may be fixed to the one side of the rotor shaft 32.

The first opening 11A is provided with a bearing BR11 (for example, a ball bearing) on the other side that rotatably supports a straight body portion that is on the other side of the rotor shaft 32 and on which the screw-shaped gear G1 is not formed.

In addition, the cover CV includes a third opening CV1 provided at a position corresponding to the rotor shaft 32, and the third opening CV1 is provided with a bearing BR12 (for example, a ball bearing) on the one side and that rotatably supports an end on the one side of the rotor shaft 32 on which the screw-shaped gear G1 is not formed.

As described above, the rotor shaft 32 is rotatably supported by the pair of bearings BR11 and BR12, whereby the rotor 30 is rotatably provided.

In addition, the second opening 11B is provided with a bearing BR21 (for example, a ball bearing) on the other side that rotatably supports the end on the other side of the output shaft OPA.

Furthermore, the cover CV includes a fourth opening CV2 that is provided at a position corresponding to the output shaft OPA and through which the output shaft OPA is led to the outside, and the fourth opening CV2 is provided with a bearing BR22 (for example, a ball bearing) on one side that rotatably supports an intermediate portion of the output shaft OPA.

As described above, the output shaft OPA is rotatably supported by the pair of bearings BR21 and BR22.

### Stator 20

The stator 20 includes: a stator core 21; and a stator coil that is wound around teeth (not illustrated) of the stator core 21 and has coil ends 22 located on an end face of the stator core 21 in the axial direction.

The stator 20 is fixed to the second member 12 of the motor housing part 10 by using a screw N or the like, using a portion of the stator core 21 on the radially outer side of a portion on which the stator coil is located.

### Rotor 30

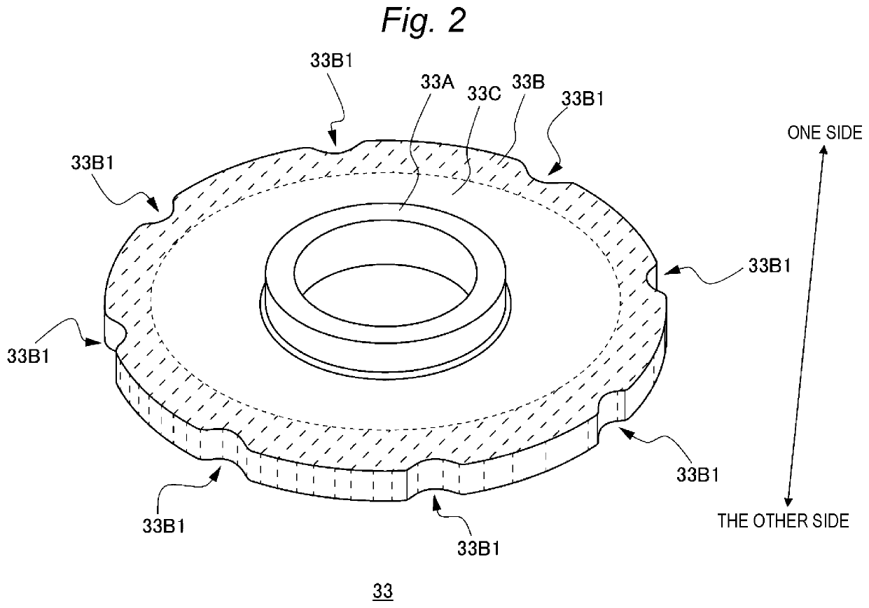

FIG. 2 is a perspective view illustrating a coupling member 33 of the embodiment according to the present disclosure, and is a perspective view in which one side is visible.

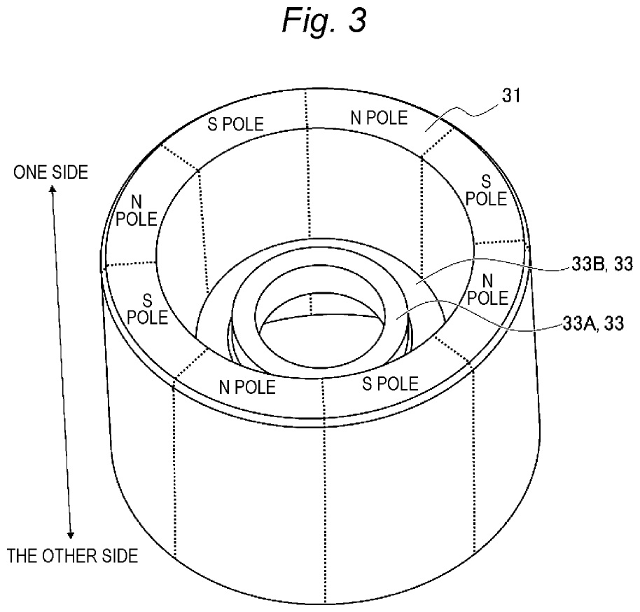

FIG. 3 is a perspective view illustrating a state in which a magnet body 31 is provided on the coupling member 33 of the embodiment according to the present disclosure, and is a perspective view in which one side is visible.

As illustrated in FIG. 1, the rotor 30 includes: the magnet body 31 having a cylindrical shape (see FIG. 3); the rotor shaft 32 provided on a radially inner side of the magnet body 31 to be separated from the magnet body 31; and the coupling member 33 that couples the magnet body 31 and the rotor shaft 32.

As illustrated in FIG. 3, the magnet body 31 is provided with N poles and S poles alternately in the circumferential direction, so that the magnet body can be rotated by a rotating magnetic field generated by the stator 20.

As illustrated in FIG. 1, the screw-shaped gear G1 (worm) is formed on the one side of the rotor shaft 32, and the screw-shaped gear G1 constitutes one gear of the reduction mechanism G.

As illustrated in FIGS. 2 and 3, the coupling member 33 is a disk-shaped member including: an outer peripheral portion 33B located in the magnet body 31; an intermediate portion 33C provided on a radially inner side from the outer peripheral portion 33B; and a cylindrical wall portion 33A that is formed at a radially central portion of the intermediate portion 33C so as to rise on the one side in the axial direction (also referred to as one axial side) and through which the rotor shaft 32 is inserted.

The rotor shaft 32 is fixed to the cylindrical wall portion 33A by shrink fitting or press fitting, for example.

That is, the disk-shaped member serving as the coupling member 33 includes the outer peripheral portion 33B embedded in the magnet body 31, whereby the disk-shaped member serving as the coupling member 33 and the magnet body 31 are integrated.

Note that a portion where the intermediate portion 33C and the outer peripheral portion 33B are combined may be referred to as a disk portion. In this case, the coupling member 33 is a disk-shaped member having: the disk portion having the outer peripheral portion 33B located in the magnet body 31; and the cylindrical wall portion 33A that is formed at a radially central portion of the disk portion so as to rise on the one side in the axial direction (also referred to as one axial side) and through which the rotor shaft 32 is inserted.

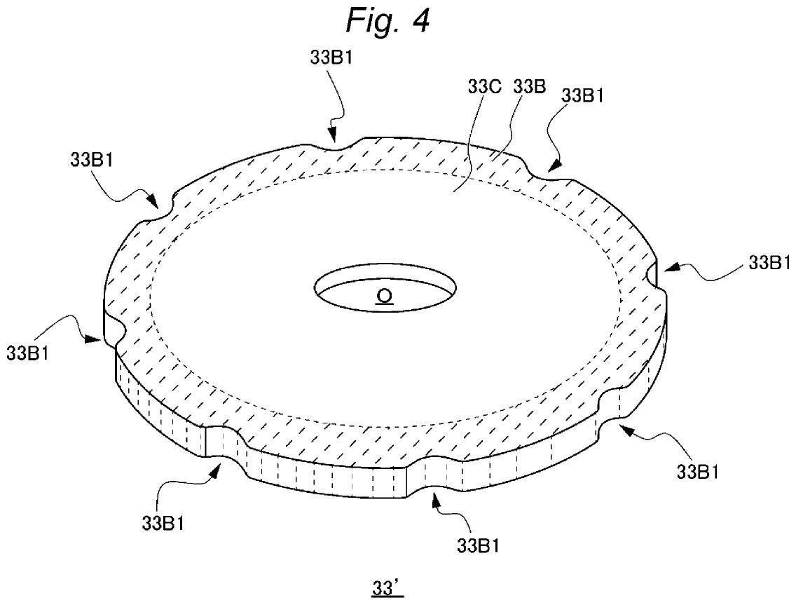

As will be described later, the cylindrical wall portion 33A is formed by performing burring processing on an opening portion O of a disk-shaped plate member 33′ (see FIG. 4) having the opening portion O at the center, and the cylindrical wall portion 33A and the disk portion (the outer peripheral portion 33B and the intermediate portion 33C) have substantially the same thin thickness.

As described above, in the present embodiment, since the coupling member 33 is made of a thin disk-shaped member, the coupling member 33 is light in weight, and the weight of the rotor 30 is therefore reduced.

Therefore, the impact load of the inertia of the rotor 30 when the actuator 1 suddenly stops is small.

On the other hand, as illustrated in FIG. 2, the disk-shaped member serving as the coupling member 33 includes in the circumferential direction a plurality of recessed portions 33B1 that are formed in the outer peripheral portion 33B and recessed radially inward. When the magnet body 31 is formed, a material of the magnet body 31 enters the recessed portions 33B1, thereby suppress movement of the magnet body 31 in the circumferential direction.

### Output Shaft OPA

The output shaft OPA includes: a shaft portion connected to the drive unit for moving the sliding door; and a helical gear G2 (also referred to as a worm wheel) integrally formed by insert molding on the other side of the shaft portion. The helical gear G2 constitutes one gear of the reduction mechanism G.

### Reduction Mechanism G

The reduction mechanism G includes: a plurality of gears (in this example, the screw-shaped gear G1 (worm) formed on the rotor shaft 32; and the helical gear G2 (worm wheel) formed on the output shaft OPA) that transmit the rotation of the motor M to the output shaft OPA.

However, the number of gears of the reduction mechanism G is not limited to two, and the reduction mechanism G may have three or more gears according to a reduction ratio or the like.

As described above, in the rotor 30 of the motor M of the present embodiment, since the coupling member 33 is made of a thin disk-shaped member formed by performing burring processing on the disk-shaped plate member 33′ (see FIG. 4), the weight of the rotor 30 is reduced.

Therefore, since the impact load of the inertia of the rotor 30 is small, it is not necessary to increase the strength of the portion that receives the impact load.

For this reason, it is not necessary to increase the thickness of the portion that receives the impact load or to use a component for reinforcement, so that the weight of the actuator 1 can be reduced.

In addition, since the outer peripheral portion 33B of the disk-shaped member serving as the coupling member 33 is located in the magnet body 31, the coupling member 33 and the magnet body 31 are fixed without using an adhesive.

On the other hand, in a case where the magnet is fixed to the peripheral surface of the cylindrical portion as in the conventional technique, if an adhesive is used, for example, there is an in convenience that not only cost increases but also design must be performed in consideration of characteristics of the adhesive at a design stage; however, the present embodiment does not have such an inconvenience.

### Method for Manufacturing Rotor 30

Next, a method for manufacturing the rotor 30 of the motor M will be described.

The method for manufacturing the rotor 30 includes: a first step of manufacturing the coupling member 33 that couples the magnet body 31 having a cylindrical shape and the rotor shaft 32; a second step of integrally providing the magnet body 31 on the coupling member 33; and a third step of attaching the rotor shaft 32 to the coupling member 33.

### First Step

The first step includes a pressing step and a burring step, and is a step of manufacturing the disk-shaped member serving as the coupling member 33.

FIG. 4 is a perspective view illustrating the disk-shaped plate member 33′ formed in the pressing step of the embodiment according to the present disclosure.

Specifically, the pressing step is a step of manufacturing from a flat plate material, by press working using a press molding machine, the disk-shaped plate member 33′ having the opening portion O at the central portion and having the recessed portions 33B1 recessed radially inward in the outer peripheral portion 33B as illustrated in FIG. 4.

An inner diameter of the opening portion O is formed smaller than an outer diameter of a burring punch used in the burring step.

The burring step is a step of forming the cylindrical wall portion 33A that rises on one side and through which the rotor shaft 32, which is illustrated in FIG. 2, is inserted, by performing burring processing in which a burring punch (that is a press-fitting rod) having an outer diameter slightly smaller than an outer diameter of the straight body portion of the rotor shaft 32 is press-fitted into the opening portion O of the disk-shaped plate member 33′ by using a burring machine.

A height of the cylindrical wall portion 33A required to obtain such strength as to fix the rotor shaft 32 can be obtained according to a press-fit stroke of the burring punch.

As described above, since the first step of the present embodiment is performed using an inexpensive working method, the disk-shaped member serving as the coupling member 33 can be manufactured at low cost.

### Second Step

The second step includes: a molding step of performing insert molding; and a magnetizing step of performing magnetization.

The molding step is a step as follows. The disk-shaped member serving as the coupling member 33 is disposed in a molding die for performing insert molding, a material (for example, a material in which a magnet powder and a resin are mixed) for the magnet body 31 is injected into the molding die, and the magnet body 31 having a cylindrical shape is thereby formed such that the outer peripheral portion 33B of the disk-shaped member (see FIG. 2) serving as the coupling member 33 illustrated in FIG. 3 is embedded in the magnet body 31.

The magnetizing step is a step of applying a strong magnetic field to the magnet body 31 formed in the molding step so as to form N poles and S poles alternately in the circumferential direction as illustrated in FIG. 3.

As described above, since the first step of the present embodiment is a step of integrating the magnet body 31 without using an adhesive or the like on the disk-shaped member serving as the coupling member 33, there is no inconvenience of performing design in consideration of the characteristics of the adhesive or the like at the design stage.

In addition, since only the insert molding and the magnetization are performed, the process is inexpensive, and it is possible to manufacture at low cost a member in which the disk-shaped member serving as the coupling member 33 and the magnet body 31 are integrated.

### Third Step

The third step is a step of attaching the rotor shaft 32 to the coupling member 33, and is specifically a step as follows. The rotor shaft 32 is fitted in the cylindrical wall portion 33A of the disk-shaped member serving as the coupling member 33 by shrink fitting, press fitting, or the like.

As described above, according to the method for manufacturing the rotor 30 of the motor M of the present embodiment, the rotor 30 can be manufactured by an inexpensive process, and the coupling member 33 is manufactured as an extremely lightweight disk-shaped member, so that the weight of the rotor 30 can be reduced and the impact load of the inertia of the rotor 30 can be reduced.

Therefore, the motor M including the rotor 30 of the present embodiment can suppress an increase in cost due to increasing in strength of the member to be connected to the rotor shaft 32.

Although the description has been made based on a specific embodiment, the present disclosure is not limited to the above embodiment.

The above embodiment has described the case where the coupling member 33 has the cylindrical wall portion 33A. However, the disk-shaped plate member 33′ having the opening portion O at the central portion is manufactured in the pressing step of the first step; therefore, needless to explain, it is understood that the intermediate portion 33C has the opening portion O at the central portion at this point of time.

Therefore, although the cylindrical wall portion 33A can more stably fix the rotor shaft 32, it goes without saying that it can be understood by those skilled in the art that the following configuration may be adopted. The cylindrical wall portion 33A is not formed and is therefore omitted, and the rotor shaft 32 is inserted into and fixed to the opening portion O at the central portion of the intermediate portion 33C formed in the pressing step of the first step.

As described above, in the present disclosure, when modifications and improvements have been made to the embodiments, the modified and improved embodiments are also included in the technical scope, and this is apparent to those skilled in the art from the description of the claims.

Note that, regarding the above embodiment, the following supplementary notes are further disclosed.

### Supplementary Note 1

A rotor of a motor, the rotor including:
a magnet body having a cylindrical shape;
a rotor shaft provided on a radially inner side of the magnet body to be separated from the magnet body; and
a coupling member that couples the magnet body and the rotor shaft,
wherein the coupling member is a disk-shaped member including:
an outer peripheral portion located in the magnet body;
an intermediate portion provided on a radially inner side from the outer peripheral portion; and
a cylindrical wall portion that is formed at a radially central portion of the intermediate portion so as to rise on one axial side and through which the rotor shaft is inserted.

### Supplementary Note 2

The rotor according to Supplementary note 1, wherein the disk-shaped member includes a plurality of recessed portions that are formed in the outer peripheral portion and recessed radially inward in a circumferential direction.

### Supplementary Note 3

The rotor according to Supplementary note 1 or 2, wherein the magnet body is provided with N poles and S poles alternately in a circumferential direction.

### Supplementary Note 4

An actuator including:
a motor including the rotor according to any one of Supplementary notes 1 to 3; and
an output shaft that rotates by rotation of the motor; and
a reduction mechanism provided between the motor and the output shaft, the reduction mechanism including a plurality of gears that transmit the rotation of the motor to the output shaft.

### Supplementary Note 5

A method for manufacturing a rotor of a motor, the method including:
a first step of manufacturing a coupling member that couples a magnet body having a cylindrical shape and a rotor shaft; and
a second step of integrally providing the magnet body on the coupling member;
wherein the first step includes:
a pressing step of forming a disk-shaped plate member having an opening portion in a central portion of the disk-shaped plate member by press working; and
a burring step of performing burring processing on the opening portion to form a cylindrical wall portion that rises on one side and in which the rotor shaft is inserted.

In addition, the following supplementary notes are also disclosed regarding the above embodiment.

### Supplementary Note 1

A rotor of a motor, the rotor including:
a magnet body having a cylindrical shape;
a rotor shaft provided on a radially inner side of the magnet body to be separated from the magnet body; and
a coupling member that couples the magnet body and the rotor shaft,
wherein the coupling member is a disk-shaped member including:
an outer peripheral portion located in the magnet body; and
an intermediate portion provided on a radially inner side from the outer peripheral portion.

### Supplementary Note 2

The rotor according to Supplementary note 1, wherein the coupling member includes a cylindrical wall portion that is formed at a radially central portion of the intermediate portion so as to rise on one axial side and through which the rotor shaft is inserted.

### Supplementary Note 3

The rotor according to Supplementary note 1 or 2, wherein the outer peripheral portion of the coupling member is embedded in the magnet body and integrated with the magnet body.

### Supplementary Note 4

The rotor according to any one of Supplementary notes 1 to 3, wherein the coupling member includes a plurality of recessed portions that are formed in the outer peripheral portion and recessed radially inward in a circumferential direction.

### Supplementary Note 5

The rotor according to any one of Supplementary note 1 to 4, wherein the magnet body is provided with N poles and S poles alternately in a circumferential direction.

### Supplementary Note 6

An actuator including:
a motor including the rotor according to any one of Supplementary notes 1 to 5; and
an output shaft that rotates by rotation of the motor; and
a reduction mechanism provided between the motor and the output shaft, the reduction mechanism including a plurality of gears that transmit the rotation of the motor to the output shaft.

### Supplementary Note 7

A method for manufacturing a rotor of a motor, the method including:
a first step of manufacturing a coupling member that couples a magnet body having a cylindrical shape and a rotor shaft; and
a second step of integrally providing the magnet body on the coupling member;
wherein the first step includes:
a pressing step of forming a disk-shaped plate member having an opening portion in a central portion of the disk-shaped plate member by press working; and
a burring step of performing burring processing on the opening portion to form a cylindrical wall portion that rises on one side and in which the rotor shaft is inserted.

### Supplementary Note 8

The method according to Supplementary note 7, wherein the second step includes a molding step of forming, by insert molding, the magnet body in which an outer peripheral portion of the coupling member is embedded in the magnet body.

The present disclosure provides a rotor of a motor having a reduced weight, an actuator including a motor having the rotor, and a method for manufacturing the rotor.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotor of a motor, the rotor comprising:
a magnet body having a cylindrical shape;
a rotor shaft provided on a radially inner side of the magnet body to be separated from the magnet body; and
a coupling member that couples the magnet body and the rotor shaft,
wherein the coupling member is a disk-shaped member including:
an outer peripheral portion located in the magnet body; and
an intermediate portion provided on a radially inner side from the outer peripheral portion.

2. The rotor according to claim 1, wherein the coupling member includes a cylindrical wall portion that is formed at a radially central portion of the intermediate portion so as to rise on one axial side and through which the rotor shaft is inserted.

3. The rotor according to claim 1, wherein the outer peripheral portion of the coupling member is embedded in the magnet body and integrated with the magnet body.

4. The rotor according to claim 2, wherein the outer peripheral portion of the coupling member is embedded in the magnet body and integrated with the magnet body.

5. The rotor according to claim 1, wherein the coupling member includes a plurality of recessed portions that are formed in the outer peripheral portion and recessed radially inward in a circumferential direction.

6. The rotor according to claim 2, wherein the coupling member includes a plurality of recessed portions that are formed in the outer peripheral portion and recessed radially inward in a circumferential direction.

7. The rotor according to claim 1, wherein the magnet body is provided with N poles and S poles alternately in a circumferential direction.

8. The rotor according to claim 2, wherein the magnet body is provided with N poles and S poles alternately in a circumferential direction.

9. An actuator comprising:
a motor including the rotor according to claim 1; and
an output shaft that rotates by rotation of the motor; and
a reduction mechanism provided between the motor and the output shaft, the reduction mechanism including a plurality of gears that transmit the rotation of the motor to the output shaft.

10. An actuator comprising:
a motor including the rotor according to claim 2; and
an output shaft that rotates by rotation of the motor; and
a reduction mechanism provided between the motor and the output shaft, the reduction mechanism including a plurality of gears that transmit the rotation of the motor to the output shaft.

11. A method for manufacturing a rotor of a motor, the method comprising:
a first step of manufacturing a coupling member that couples a magnet body having a cylindrical shape and a rotor shaft; and
a second step of integrally providing the magnet body on the coupling member;
wherein the first step includes:
a pressing step of forming a disk-shaped plate member having an opening portion in a central portion of the disk-shaped plate member by press working; and
a burring step of performing burring processing on the opening portion to form a cylindrical wall portion that rises on one side and in which the rotor shaft is inserted.

12. The method according to claim 11, wherein the second step includes a molding step of forming, by insert molding, the magnet body in which an outer peripheral portion of the coupling member is embedded in the magnet body.
